(19) United States
(12) Patent Application Publication
(10) Pub. No.: US 2008/0148810 A1
(43) Pub. Date: Jun. 26, 2008

(54) Device For Determining the Level of a Fluid

(76) Inventors: Alfred Boehm, Viechtach (DE); Dieter Lerach, Zwiesel (DE)

Correspondence Address: JACOBSON HOLMAN PLLC, 400 SEVENTH STREET N.W., SUITE 600, WASHINGTON, DC, 20004, US

(21) Appl. No.: 11/793,033

(22) PCT Filed: Oct. 10, 2005
(86) PCT No.: PCT/EP2005/010895

§ 371 Date: Jun. 15, 2007

(30) Foreign Application Priority Data
Dec. 16, 2004 (DE) 20 2004 019 4422

(51) Int. Cl. G01N 27/07

(52) U.S. Cl. 73/19.1

(57) ABSTRACT

The invention relates to a device for determining the degree of filling of a fluid in a measuring chamber, with a measuring chamber wall surrounding the measuring chamber and at least two planar electrodes arranged in facing manner in the vicinity of the measuring chamber wall in the measuring chamber. The measuring chamber wall is constructed in electrically insulating manner in insulation areas, which are connected to the two electrodes and surround the same in planar manner.

The invention relates to a device according to the preamble of claim 1 for determining the degree of filling of an in particular flowing fluid in a measuring chamber, with a measuring chamber wall surrounding the measuring chamber and in which is provided at least one opening for introducing and/or discharging the fluid, and at least two planar electrodes, which are positioned facing one another in the vicinity of the measuring chamber wall in the measuring chamber.

A device for determining the degree of filling of a fluid is e.g. known from EP 0 617 789 B1. The device known from said specification has a measuring tube through which flows a fluid and housing an electrode pair, whose individual electrodes are positioned on opposite measuring tube walls. This electrode pair is used for detecting the conductivity of the fluid flowing through the measuring tube, the conductivity being a measure of the degree of filling. There is also another electrode pair which forms part of a magnetically inductive flowmeter used for detecting the fluid delivery rate in the measuring tube.

A further such device is known from EP 0 626 567 B1. EP 0 626 567 B1 discloses a device for the simultaneous determination of the flow rate and the degree of filling in a measuring line. The device has a common electrode pair used both for determining the fluid flow rate with a magnetically inductive flowmeter and for determining the degree of filling with a conductivity measuring device. The measuring line of the known device comprises a metallic tube in which is formed a portion with a rectangular flow cross-section. The rectangular section has at its two longitudinal sides in each case one planar single electrode of the electrode pair. The single electrodes are electrically insulating with respect to the metallic tube.

The object of the invention is to provide a device for determining the degree of filling in a measuring chamber permitting a particularly high accuracy of measurement.

According to the invention this object is achieved by a device having the features of claim 1. Preferred embodiments are given in the dependent claims.

The device according to the invention is characterized in that the measuring chamber wall has an electrically insulating construction in insulation areas connected to both electrodes and surrounding the same in planar manner.

It is a fundamental idea of the invention that the measuring chamber walls which are in fluid contact have an at least sectionwise insulating construction in the area round the two electrodes. This creates an extended insulation area on the measuring chamber wall. The invention is based on the finding that when electrically conductive measuring chamber walls exist, there is a danger of electric currents between the electrodes being born not solely by the fluid in the measuring chamber and instead such currents also form in the measuring chamber wall. For example an electric charge can flow from one electrode into the fluid, from there into the conductive measuring chamber wall, from there into the fluid and finally to the second electrode. However, such shunts reduce the precision in determination of the degree of filling, because the measured conductance does not solely reproduce the fluid conductivity but also the conductivity of the electrically conductive measuring chamber wall. This makes necessary complicated compensation methods when evaluating the electrode currents.

The device according to the invention can also be referred to as a bubble or air bubble sensor, because it can be used for determining gas bubbles and/or gas fractions in a liquid. These fractions can be referred to as the degree of filling. The gas can in particular be air and the fluid is a liquid. The fluid is appropriately electrically conductive for a conductivity measurement. The fluid can e.g. incorporate water and the fluid can in particular be dairy products, e.g. milk. Insulation in the present invention is understood to mean electrical insulation or galvanic isolation.

According to the invention at least one insulation area is provided on each of the two electrodes. The individual insulation areas can also pass into one another. In particular, according to the invention, the insulation areas can pass into one another in such a way that one or more common insulation areas are formed, which are connected to both the facing electrodes. According to the invention the insulation areas surround in planar manner the planar electrodes. The insulation areas can also extend into those measuring chamber wall areas located beneath the electrodes, i.e. into those areas which are covered from the fluid in the measuring chamber by the planar electrodes.

In principle, a single opening can be provided on the inventive measuring chamber wall and is then used both for introducing fluid into the measuring chamber and for discharging fluid from the measuring chamber. Such an arrangement can in particular be advantageous if the device is used for determining the degree of filling of a stationary fluid, i.e. a fluid which does not flow at least during the measurement period. However, it is advantageous to have in the measuring chamber wall two openings for the passage of the fluid through the measuring chamber. Such an arrangement is particularly well suited to the determination of the degree of filling of a flowing fluid. Preferably the two openings are provided in facing manner in the measuring chamber wall. In principle, further openings can be provided.

A construction of the inventive device particularly suitable for the determination of the degree of filling of flowing fluids comprises the measuring chamber wall being constructed in tubular manner, at least in the vicinity of the electrodes, in the fluid flow direction. In this case the measuring chamber wall can also be referred to as a measuring tube. The measuring chamber wall can e.g. be constructed as a linearly directed tube, but also as a bent tube, e.g. a U-tube. It is particularly advantageous to construct the measuring chamber wall as a linear tube at least in the vicinity of the electrodes. As a result, in the vicinity of the electrodes, there is a particularly turbulence-free flow and therefore a high measuring accuracy. According to the invention the internal cross-section of the tubular measuring chamber wall is e.g. angular, particularly rectangular or square, and/or round, e.g. circular or elliptical.

According to the invention, the flow direction can be understood to mean the direction of movement of the flowing fluid in the measuring chamber, assuming an ideal laminar flow. In the case of tubular measuring chamber walls the flow direction more particularly coincides with the axial direction of the tube.

A particularly high measuring accuracy can, according to the invention, be achieved in that the insulation areas are positioned on either side of the electrodes in the fluid flow direction. In this embodiment the measuring chamber wall has an electrically insulating construction preferably both upstream and downstream of the planar electrodes and both the upstream insulation areas and the downstream insulation areas are connected to the given electrode. The upstream insulation areas and downstream insulation areas of the same electrode and/or of the in each case other electrode can also pass into one another.

It is particularly preferred for the insulation areas to be at least twice as wide in the fluid flow direction as the electrodes surrounded by the same. In this context the width can be understood to mean the total width of the insulation areas surrounding the given electrodes, e.g. a total width of the in each case upstream and downstream insulation area. According to this embodiment the insulated width should be at least twice the width of the given electrode. The width of the insulation areas can include the width of the electrodes located therein.

To further increase the degree of filling determination precision, according to the invention the insulation areas are at least sectionwise arranged in the cross-section of the measuring chamber between the electrodes. The insulation areas of the individual electrodes can, but need not necessarily pass into one another, accompanied by the formation of a common insulation area. The arrangement of the insulation areas between the facing electrodes can be understood to mean that the insulation areas extend transversely to the flow direction, starting from the electrodes. Preferably a bottom area and/or top area of the measuring chamber wall is electrically insulated, i.e. is constructed with at least one insulation area. The spatial arrangement of the top and bottom areas is to be more particularly considered with respect to laterally positioned electrodes. Thus, in the case of a quadrangular internal cross-section of the measuring chamber, the top and bottom areas can be understood to mean those measuring chamber wall elements which are at an angle to the measuring chamber wall elements provided with electrodes.

A further preferred embodiment comprises the electrodes terminating in planar manner with the surrounding measuring chamber wall or being set back with respect to the surrounding measuring chamber wall. Since, according to the invention, the measuring chamber wall surrounding the electrodes is at least zonally insulated, such an electrode arrangement can be brought about without giving rise to significant electrical shunts between the electrodes and the surrounding measuring chamber wall. As a result of the planar terminating electrode arrangement or where the latter is set back with respect to the measuring chamber wall, in the vicinity of the electrodes there is a particularly laminar flow and therefore a particularly good measuring accuracy. However, the electrodes can also project from the surrounding measuring chamber wall.

Particularly easily interpretable measured values can be obtained in the case of a particularly simple device construction in that the measuring chamber, particularly in the vicinity of the electrodes, has a rectangular, particularly square internal cross-section.

It is in particular advantageous for the electrodes to at least approximately have the same height as the measuring chamber. The height is preferably measured perpendicular to the fluid flow direction. The height more particularly relates to the measuring chamber wall elements on which the electrodes are located.

A constructionally particularly simple device is obtained in that two, particularly identical, electrodes are provided at facing points of the measuring chamber. Particularly in the case of a rectangular or square measuring chamber internal cross-section, the electrodes appropriately diametrically face one another.

For a particularly high measuring accuracy with easily interpretable measured values, the contact surfaces of the facing electrodes towards the interior of the measuring chamber have at least approximately the same size. The contact surfaces are in particular understood to mean the electrode surfaces for fluid contact in the measuring chamber.

For particularly easily interpretable measured values, it is also advantageous for the contact surfaces of the facing electrodes and/or the measuring chamber wall to be constructed in an at least approximately mirror-symmetrical manner in the vicinity of the electrodes. A mirror plane preferably runs in the flow direction.

If, according to the invention, besides the already mentioned electrodes, in the measuring chamber area there are also further electrodes, e.g. auxiliary electrodes, the shape, design and arrangement of these further electrodes can be fundamentally chosen in arbitrary manner with respect to the two facing electrodes.

If measurement is carried out on a flowing fluid, the electrodes are appropriately so designed that at any time a representative cross-section of a fluid line is detected. For this purpose rectangular electrodes are particularly suitable. It is also particularly preferred that the facing electrodes have at least approximately rectangular base surfaces. The term base surfaces of the electrodes can in particular be understood to mean sections of the electrodes running parallel to the in each case surrounding measuring chamber wall.

According to the invention the facing electrodes can be inclined to the flow direction and are in particular constructed with at least approximately parallel base surfaces. Particularly when using inclined electrodes, it can be advantageous for all the air bubbles to move with the same time path length over or between the electrodes and to be located in the area of the laminar flow. Preferably the electrodes are constructed in such a way that their width is at least approximately constant over the total height. However, as frequently the flow rate in the centre of the measuring chamber is higher than at the measuring chamber walls, it can be advantageous to vary the electrode width over the electrode height.

When using sloping or inclined electrodes, it is preferable for the second, facing electrode to have the same sloping or inclined position as the first electrode. In a three-dimensional representation, between the electrodes this leads to a body with a constant side length, e.g. a cube or prism. For dimensioning the electrodes use can in particular be made of Cavalieri's theorem.

According to another preferred embodiment of the invention the facing electrodes are mutually displaced in the fluid flow direction.

It is particularly advantageous for the insulation areas of the measuring chamber wall to be surrounded by conductive areas in which the measuring chamber wall is electrically conductive and in particular metallic, the at least one opening being preferably provided in the conductive areas. As a result of the metallic construction of the measuring chamber wall in the vicinity of the opening a particularly robust device can be obtained. Through the electrically conductive construction of the measuring chamber wall in the conductive areas it is also possible to shield the electrodes with respect to electromagnetic interference.

It is possible to construct the measuring chamber wall in a continuous insulating manner in the insulation areas. However, it is preferable for the measuring chamber wall to have an insulating layer in the insulation areas. In this case the measuring chamber wall in the insulation areas can also be electrically conductive, particularly metallic below the insulating layer. With the arrangement of an insulating layer on an otherwise conductive layer, on the one hand it is possible to achieve an adequate insulation of the wall with respect to the electrodes and/or the fluid and on the other a particularly effective shielding of the measuring chamber against electromagnetic interference.

According to the invention, it is advantageous to provide a voltage source, particularly an a.c. voltage source, which is in conductive connection with the electrodes by means of supply lines, and for a current detection device for measuring a current to be provided in at least one of the supply lines. In this case, by means of the inventive device it is possible to carry out a conductivity measurement and from the fluid conductivity conclusions can be drawn regarding the degree of filling in the measuring chamber. It is optionally possible to determine the degree of filling by means of a capacitance measurement, the electrodes being constructable as capacitor plates and the fluid, particularly the liquid and the gas contained therein, forming the dielectric. If a capacitance measurement is performed, the electrodes can also be electrically insulated relative to the measuring chamber interior or the fluid.

A particularly compact and easily transportable device is obtained according to the invention in that a housing is provided, which contains the measuring chamber wall. Preferably the voltage source and/or current detection device is provided on, more particularly in the housing. The housing can e.g. be constructed as a tube, in which is positioned, more particularly in spaced manner, the measuring chamber wall. For electromagnetic shielding purposes the housing is preferably electrically conductive and in particular metallic.

It is advantageous to install a control and/or evaluation electronics in the housing or in the immediate vicinity thereof.

The invention is described in greater detail hereinafter relative to preferred embodiments and the attached diagrammatic drawings, wherein show:

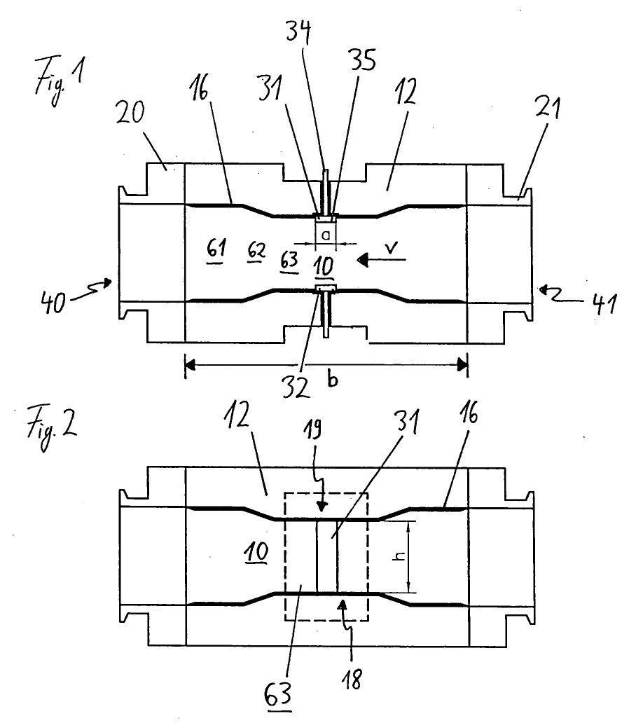

FIG. 1 A longitudinal section from above of an inventive device in a first embodiment.

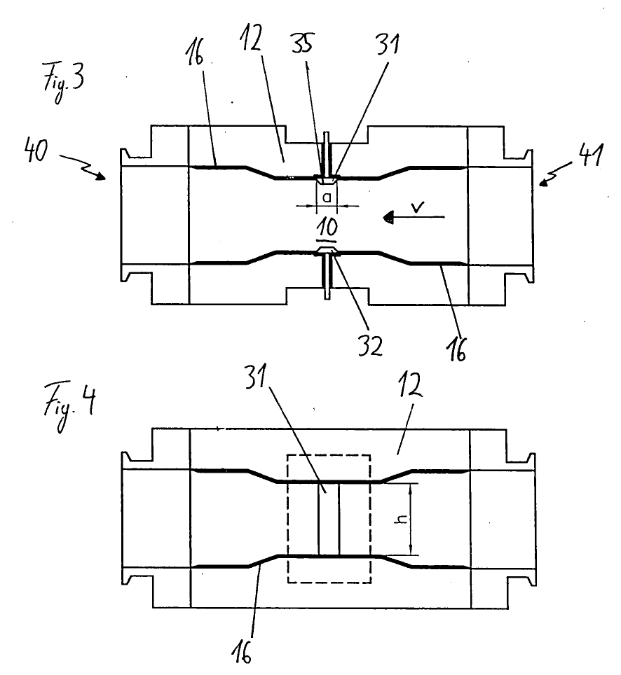

FIG. 2 A longitudinal section from the side of the device of FIG. 1.

FIG. 3 A longitudinal section from above of an inventive device in a second embodiment.

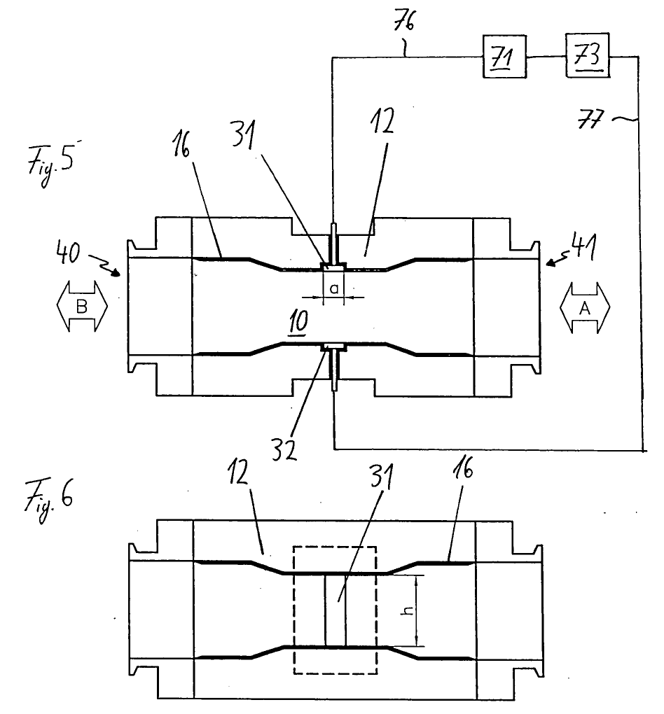

FIG. 4 A longitudinal section from the side of the device of FIG. 3.

FIG. 5 A longitudinal section from above of an inventive device in a third embodiment.

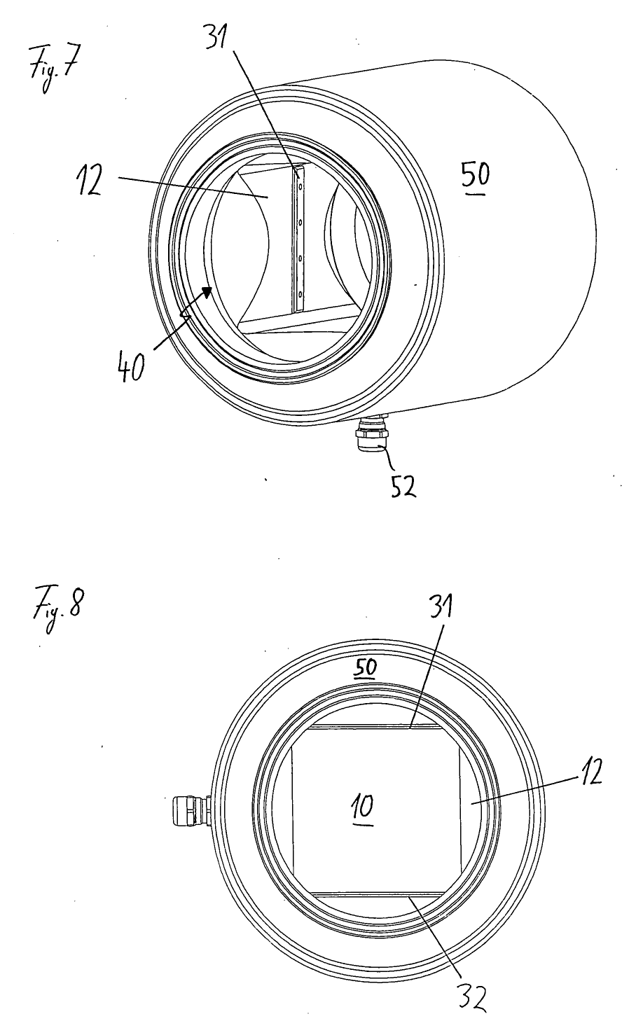

FIG. 6 A longitudinal section from the side of the inventive device of FIG. 5.

FIG. 7 A perspective view of an inventive device in a fourth embodiment.

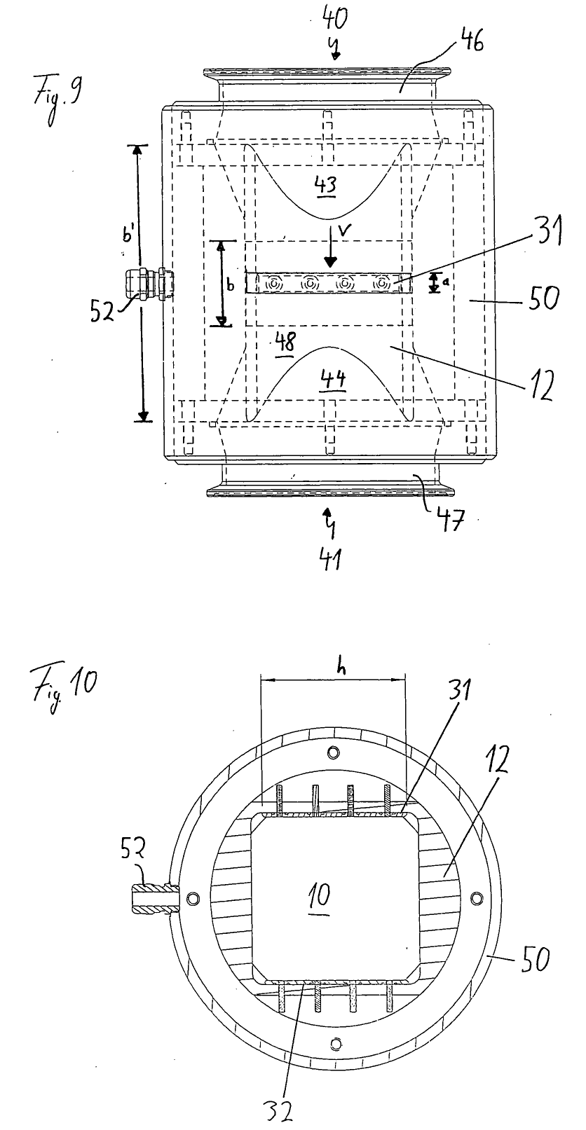

FIG. 8 A side view on a face side of the device of FIG. 7.

FIG. 9 A plan view of the device of FIGS. 7 and 8 with concealed edges and outlines.

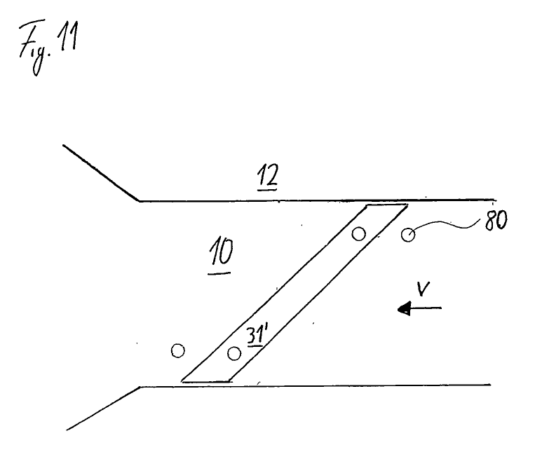

FIG. 10 A cross-sectional view of the device of FIGS. 7 to 9 on the level of the line passage.

FIG. 11 An inventive device in a fifth embodiment.

Identically acting elements are given the same reference numerals in all the drawings.

FIGS. 1 and 2 show an inventive device for determining the degree of filling of a flowing fluid in a first embodiment. The device has a measuring chamber wall 12 defining a measuring chamber 10 in the interior of the device. Measuring chamber 10 has an elongated construction. On opposing face sides of measuring chamber 10 is provided an opening 41 for introducing fluid into measuring chamber 10 and an opening 40 for discharging fluid from measuring chamber 10. Terminally and in the vicinity of openings 40, 41 a coupling flange 20, 21 is in each case provided on the measuring chamber wall 12 for flanging the inventive device in a line. The inventive device can consequently be used for degree of filling determination in a line.

As is shown in exemplified manner on the left-hand side of measuring chamber 10 in FIG. 1, said measuring chamber 10 has areas of differing cross-section. The cross-section is considered perpendicular to the ideal laminar flow direction v of the fluid in measuring chamber 10, which coincides with the longitudinal axis of the latter. To a first, external measuring chamber area 61 with a constant cross-section is connected towards the measuring chamber interior a tapering measuring chamber area 62, where the cross-section decreases towards the measuring chamber interior. To this is in turn connected a third measuring chamber area 63 with a constant cross-section. In said third measuring chamber area 63 the measuring chamber 10 is constructed with a rectangular, particularly square cross-section. Measuring chamber 10 has a mirror symmetrical construction, a plane of symmetry running perpendicular to the fluid flow direction v. Thus, corresponding to the measuring chamber areas 61 to 63 there are areas to the right in measuring chamber 10. For forming the rectangular measuring chamber cross-section in the third measuring chamber area 63, measuring chamber wall 12 in said area 63 has four wall elements running perpendicular to one another.

On measuring chamber wall 12 in the third measuring chamber area 63 two electrodes 31, 32 face one another perpendicular to flow direction v. For determination of the degree of filling a voltage is applied between these two electrodes 31, 32 and it is preferably in the form of an a.c. voltage, which produces a current corresponding to the conductance of the fluid in or flowing through measuring chamber 10. This current is detected for conductance determination purposes.

Electrode 31 is T-like in the longitudinal section from above in FIG. 1. At the head side said electrode 31 has a contact surface 35 directed towards the measuring chamber interior and where the electrode 31 is in contact with the fluid in measuring chamber 10. In the embodiment of FIG. 1 electrode 31 does not terminate in planar manner with the surrounding measuring chamber wall 12, but is instead advanced with respect to the same in step-like manner into the measuring chamber interior. Thus, the contact surface 35 has a shoulder-like construction with a longitudinal surface parallel to the flow direction and end faces perpendicular thereto. A connecting line 34 is provided on electrode 31 on the base side. Electrode 32 is constructed and positioned in accordance with electrode 31.

As shown in FIG. 2 using the example of electrode 31, electrodes 31, 32 extend over the entire height of measuring chamber 10, i.e. the height h of electrodes 31, 32 corresponds to the height of measuring chamber 10, at least in the third measuring chamber area 63. Thus, electrodes 31, 32 extend along the entire height of facing, parallel inner surfaces of measuring chamber wall 12.

Electrodes 31, 32 are galvanically isolated relative to measuring chamber wall 12, which can in particular be constructed as a tube. For this purpose on the inner surface of measuring chamber wall 12 is provided an insulating layer 16, e.g. a plastic layer.

Insulating layer 16 is located in the vicinity of the connecting lines 34 of electrodes 31, 32 and between their head-side ends and measuring chamber wall 12, i.e. below electrodes 31, 32. Insulating layer 16 is also provided upstream and downstream of the electrodes 31, 32 in the fluid flow direction v, so that planar insulating areas are formed on measuring chamber wall 12 and surround the two electrodes 31, 32. These insulating areas have a width b, which is preferably at least twice and in particular up to fifteen times an electrode width a. Advantageously the insulating areas 16 extend between flanges 20, 21 along the entire measuring chamber wall 12.

As can be gathered from FIG. 2, the insulating layer 16 is also provided in the bottom area 18 and top area 19 of measuring chamber 10, i.e. on the inner surfaces of measuring chamber wall 12, which are spaced and perpendicular to electrodes 31, 32.

If an insulating layer 16 is provided, the measuring chamber wall 12 can otherwise be made from electrically conductive material, e.g. metal. However, it is also possible to construct the measuring chamber wall 12 in a continuous electrically insulating manner, so that there is no need for an insulating layer 16 in the insulation areas.

Another embodiment of an inventive device is shown in FIGS. 3 and 4. In this embodiment the only difference from that of FIGS. 1 and 2 is that the electrodes 31, 32 have chamfered contact surfaces 35 relative to flow direction v. According to the longitudinal section of FIG. 3, the contact surfaces 35 have two end faces, which are at an angle of approximately 45° to the flow direction v and between said end faces there is a longitudinal surface running parallel to flow direction v.

The embodiment of FIGS. 5 and 6 differs from that of FIG. 1 in that the electrodes do not project from the measuring chamber wall 12 and are instead positioned flush in measuring chamber wall 12. The contact surfaces 35 of electrodes 31, 32 are planar.

FIG. 5 diagrammatically shows a voltage source 71 connected by supply lines 76, 77 to electrodes 31, 32. In supply line 77 is provided a current detection device 73 for measuring the current through electrode 32. Correspondingly wired voltage sources 71 and current detection devices 73 can also be used in the other embodiments shown.

A fourth embodiment of an inventive device is shown in FIGS. 7 to 10. This embodiment has a tubular housing 50 containing the measuring chamber wall 12 with measuring chamber 10. The material of the measuring chamber wall 12 can differ from that of the housing 50 and/or the wall 12 can be spaced from the housing. Housing 50 can contain control and evaluation electronics for electrodes 31, 32. For the electrical connection of said electronics and/or the two electrodes 31, 32 a line passage 52 is centrally provided on housing 50.

As can in particular be gathered from FIG. 9, the measuring chamber wall 12 of the fourth embodiment has two conical areas 43, 44 on which are terminally provided coupling flanges 46, 47. In said coupling flanges 46, 47 are formed the openings 40, 41 of measuring chamber wall 12, said two openings 40, 41 having a roughly circular cross-section. Starting from openings 40, 41 the cross-section of measuring chamber 10 tapers continuously in the conical areas 43, 44 and in a central area 48 of measuring chamber 10 passes into a rectangular cross-section. The two electrodes 31, 32 are located in said central area 48.

As can be gathered from FIG. 9, the insulation areas of the fourth embodiment have a total width which, including the electrodes 31, 32 located therein, roughly corresponds to four times the width b of electrode width a. The insulation areas can also be constructed with a much greater width b′.

A further embodiment of an inventive device is shown in FIG. 11. According to the embodiment of FIG. 11 in place of the rectangular electrodes are provided parallelogram-like electrodes 31′ inclined to the flow direction v. The parallelogram-like construction ensures that the electrodes 31′ have the same width over the entire cross-section of measuring chamber 10. Air bubbles 80 moving with the fluid in flow direction v through measuring chamber 10, independently of their position in the cross-section of the measuring chamber 10, constantly always experience the same measuring section.

1. Device for determining the degree of filling of an in particular flowing fluid in a measuring chamber (10), having
a measuring chamber wall (12) surrounding the measuring chamber (10) and in which is provided at least one opening (40, 41) for the introduction and/or discharge of the fluid and
at least two planar electrodes (31, 32) arranged in facing manner in the vicinity of the measuring chamber wall (12) in the measuring chamber (10), characterized in that
the measuring chamber wall (10) has an electrically insulating construction in insulation areas connected to the two electrodes (31, 32) and surrounding the latter in planar manner.

2. Device according to claim 1,
characterized in that
in the measuring chamber wall (12) are formed two openings (40, 41) for the passage of the fluid through the measuring chamber (10) and
the measuring chamber wall (12) has a tubular construction in the fluid flow direction (v), at least in the vicinity of electrodes (31, 32).

3. Device according to one of the claims 1 or 2,
characterized in that
the insulation areas are positioned on either side of the electrodes (31, 32) in the fluid flow direction (v).

4. Device according to one of the claims 1 to 3,
characterized in that,
in the fluid flow direction (v), the insulation areas are at least twice as wide as the electrodes (31, 32) in each case surrounded by the same.

5. Device according to one of the claims 1 to 4,
characterized in that
the insulation areas are at least sectionwise located between the electrodes (31, 32) in the cross-section of the measuring chamber (10)

6. Device according to one of the claims 1 to 5,
characterized in that
the electrodes (31, 32) terminate in planar manner with the surrounding measuring chamber wall (12) or are set back with respect to the surrounding measuring chamber wall (12).

7. Device according to one of the claims 1 to 6,
characterized in that
the measuring chamber (10), particularly in the vicinity of electrodes (31, 32), has a rectangular, particularly square internal cross-section.

8. Device according to one of the claims 1 to 7,
characterized in that
the electrodes (31, 32) have at least approximately the same height (h) as the measuring chamber (10).

9. Device according to one of the claims 1 to 8,
characterized in that
there are two, particularly identical electrodes (31, 32) at facing points of the measuring chamber (10).

10. Device according to one of the claims 1 to 9,
characterized in that
contact surfaces (35) of the facing electrodes (31, 32) towards the interior of the measuring chamber (10) have at least approximately the same size.

11. Device according to one of the claims 1 to 10,
characterized in that
the contact surfaces (35) of the facing electrodes (31, 32) have an at least approximately mirror-symmetrical construction.

12. Device according to one of the claims 1 to 11,
characterized in that
the facing electrodes (31, 32) have at least approximately rectangular base surfaces.

13. Device according to one of the claims 1 to 12,
characterized in that
the facing electrodes (31, 32) are inclined to the flow direction (v) and are in particular constructed with at least approximately parallelogram-like base surfaces.

14. Device according to one of the claims 1 to 13,
characterized in that
the insulation areas of the measuring chamber wall (12) are surrounded by conductive areas in which the measuring chamber wall (12) has an electrically conductive and in particular metallic construction, the at least one opening (40, 41) preferably being located in the conductive areas.

15. Device according to one of the claims 1 to 14,
characterized in that
in the insulation areas, the measuring chamber wall (12) has an insulating layer (16).

16. Device according to one of the claims 1 to 15,
characterized in that
a voltage source (71), particularly an a.c. voltage source is provided, which is in line connection by supply lines (76, 77) with the electrodes (31, 32) and that a current detecting device (73) is provided for measuring a current in at least one of the supply lines (76, 77).

17. Device according to claim 16,
characterized in that
a housing (50) is provided containing the measuring chamber wall (12) and that the voltage source (71) and/or current detecting device (73) is provided on and in particular in the housing (50).
